(19) United States
(12) Patent Application Publication
(10) Pub. No.: US 2008/0140384 A1
(43) Pub. Date: Jun. 12, 2008

(54) Natural-language text interpreter for freeform data entry of multiple event dates and times

(76) Inventor: George Landau, Narberth, PA (US)

Correspondence Address: George Landau, 6 Stuart Avenue, Narberth, PA, 19072, US

(21) Appl. No.: 10/858,793

(22) Filed: Jun. 2, 2004

Related U.S. Application Data
(60) Provisional application No. 60/477,836, filed on Jun. 12, 2003.

(51) Int. Cl. G06F 17/27

(52) U.S. Cl. 704/9

(57) ABSTRACT

The n.e. Thing natural language processor is a natural-language text interpreter for freeform data entry of multiple event dates and times. This invention allows a person to submit to a computer, in informal written English, complete information about the dates and times on which an event occurs or recurs, and have that text converted to a list of discrete dates and times representing each occurrence of the event in a machine-interpretable date-time format. The resulting machine-interpretable list can subsequently be used by any software application or database for maintaining a schedule or calendar that includes a reference to each occurrence of the event being described.

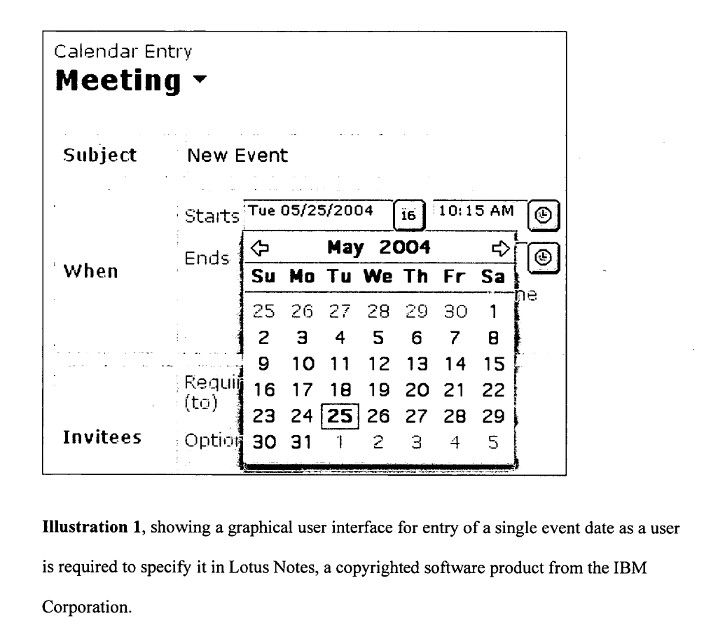

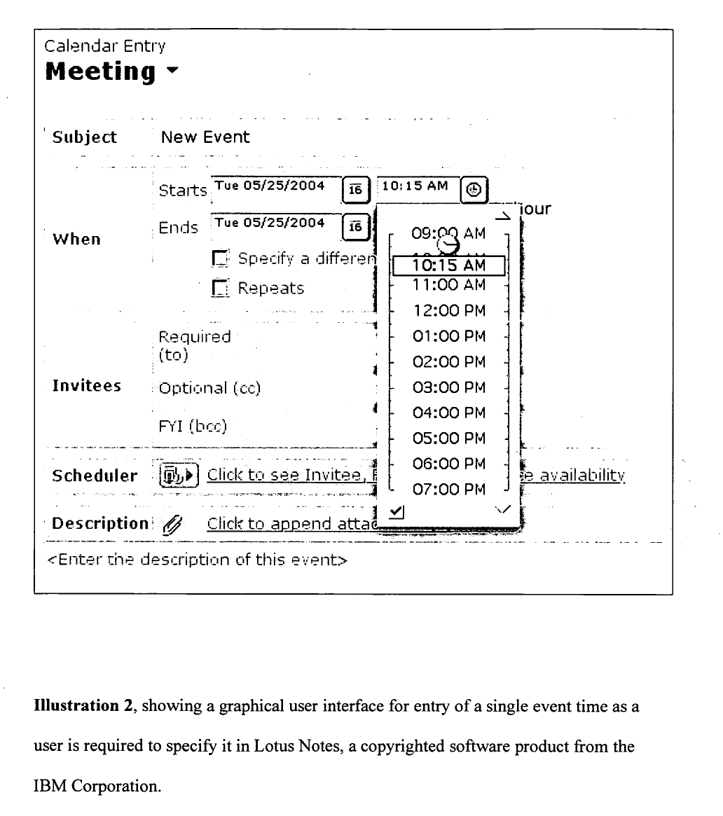

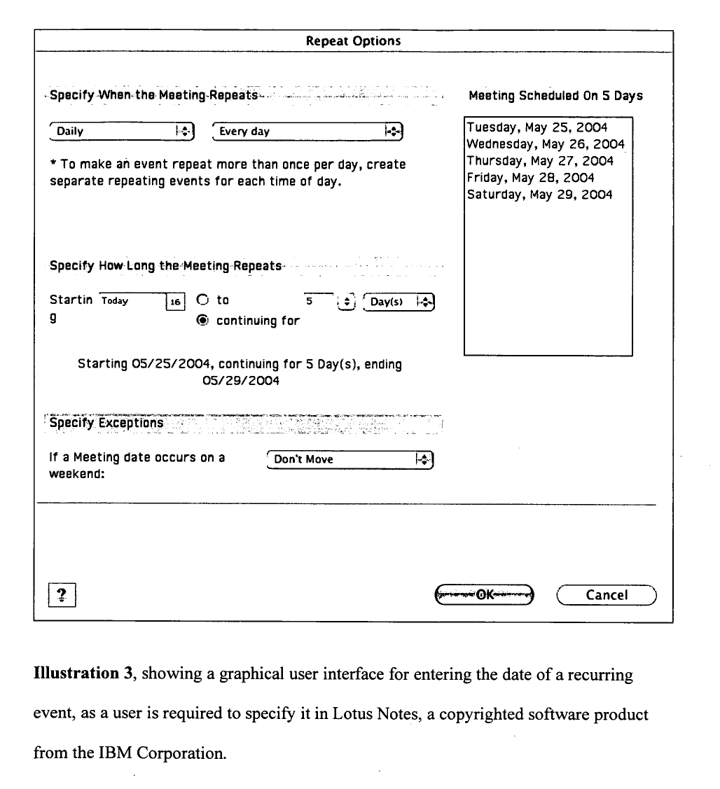

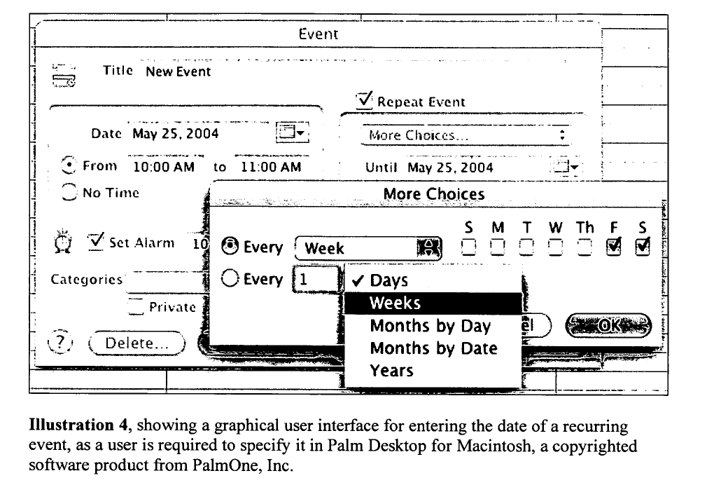

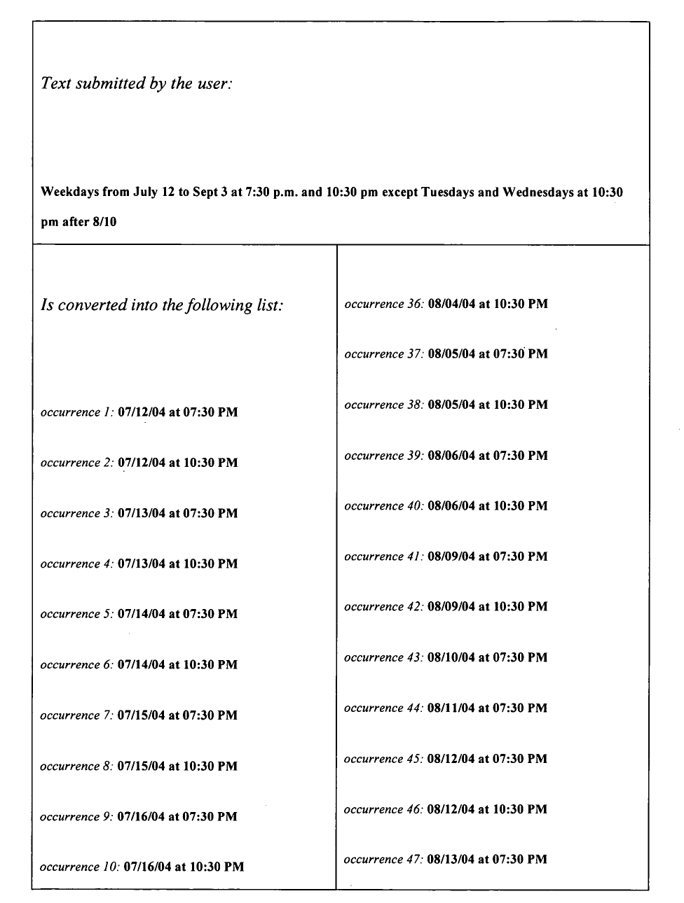

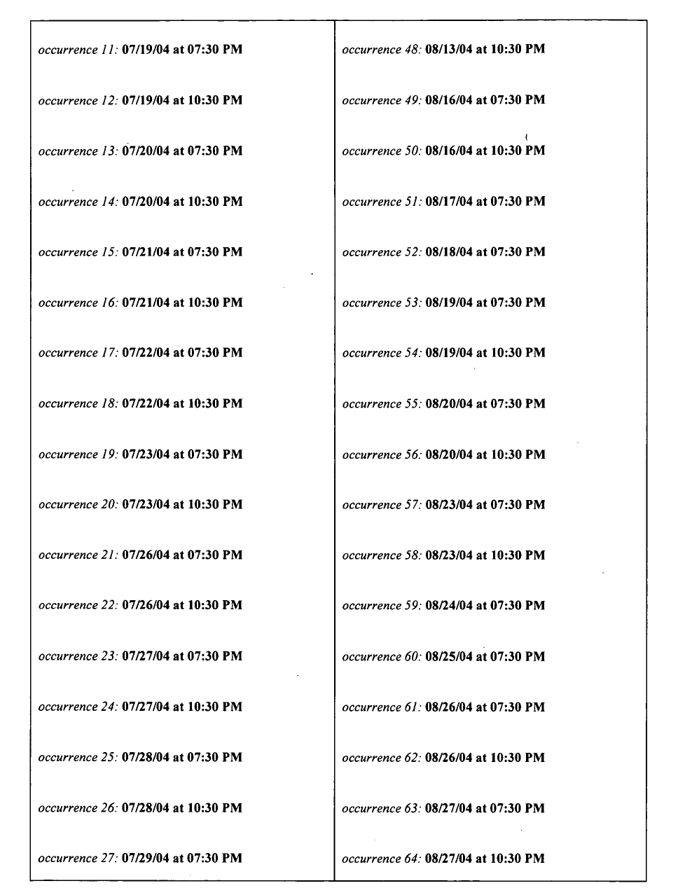

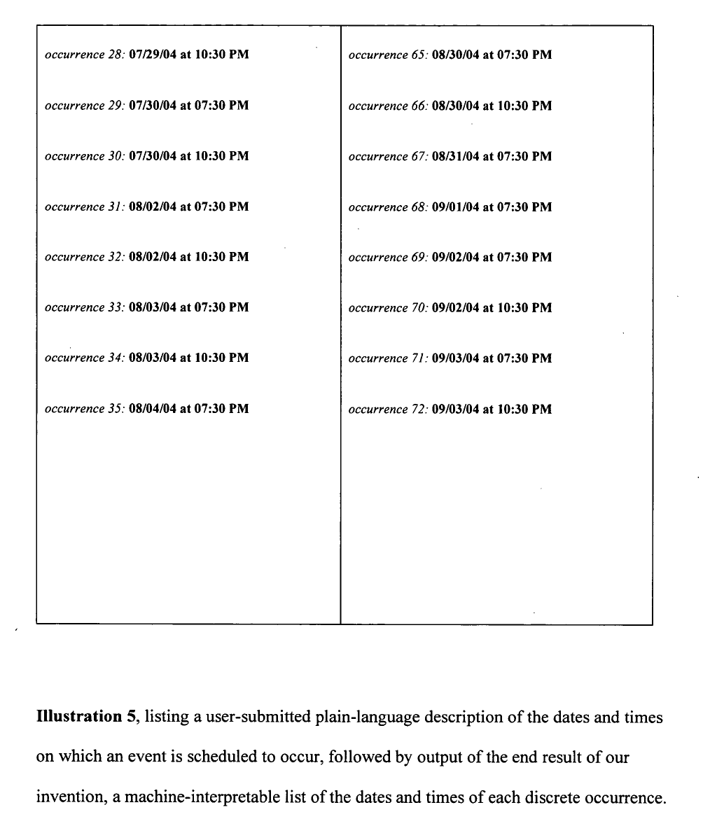

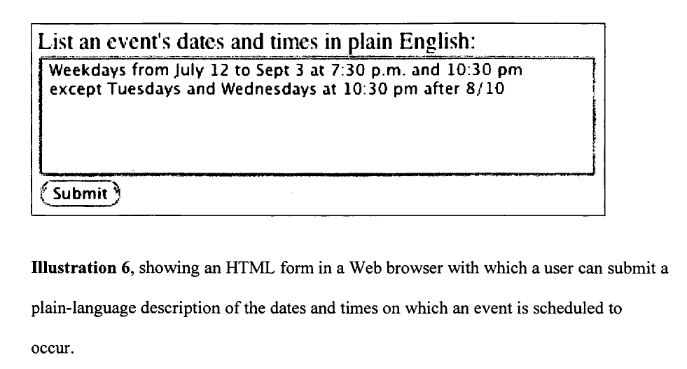

### CROSS-REFERENCE TO RELATED APPLICATIONS

Not Applicable

### STATEMENT REGARDING FEDERALLY SPONSORED RESARCH OR DEVELOPMENT

Not Applicable

### REFERENCE TO COMPUTER PROGRAM LISTING, COMPACT DISK APPENDIX

While our invention can be implemented in any modern computer language, currently it exists in the language known as PHP, which is widely used for scripting of Internet web servers. The accompanying single text file, “TextDateToArray.php,” is included on the enclosed CD-ROM and is designed to be included as a function library within a broader PHP application. All functions of our invention are carried out by code within this single file, which is designed to accept, as passed from a calling program module, a freeform textual description of an event's dates and times and then, after completing its processing, to return to the calling program module a list of machine-formatted dates and times in which the list contains a single date-time entry for each occurrence of the event.

Enclosed with this specification is a CD-ROM and an exact copy of that CD-ROM. There is one file on each of the CD-ROMs. That file is neTextDTtoArray.php. The file was created on Oct. 14, 2005. The file size is 75,890 bytes.

### BACKGROUND OF THE INVENTION

Our invention provides a novel method for computer data entry of the dates and times on which an event occurs. In particular, our invention simplifies for computer users the task of specifying date and time information for events that repeat for spans of days or recur at particular intervals.

Without our invention, computer users have been required to specify dates and times using graphical date-time choosers or by typing dates and times in a constrained format with a precise syntax, such as MM/DD/YYYY HH:MM:SS AM/PM, in which the letters indicate required digits for month, day, year, hours, minutes and seconds. In particular, computer users entering dates and times for events that recur for a given time span or at a given interval have been required to perform additional steps in a relatively complex graphical user-interface to specify the nature of the time span or repetition interval.

### BRIEF SUMMARY OF THE INVENTION

Our invention allows a person to submit to a computer, in informal written English, complete information about the dates and times on which an event occurs or recurs, and have that text converted to a list of discrete dates and times representing each occurrence of the event in a machine-interpretable date-time format. The resulting machine-interpretable list can subsequently be used by any software application or database for maintaining a schedule or calendar that includes a reference to each occurrence of the event being described. For example, the dates and times for a recurring theatrical production could be described with our invention as follows:

“Weekdays from July 12 to Sept 3 at 7:30 p.m. and 10:30 pm except Tuesdays and Wednesdays at 10:30 pm after 8/10”

When processed by our invention, the text in the example above is converted to a listing of 72 discrete performances of the theatrical production, a listing which can be chronologically sorted and searched using standard computer functions for handling dates and times. As shown in the example, our invention allows computer users to enter complex combinations of event dates and times, including recurrences and date ranges, in a single English-language expression that can be written without concern for special wording, syntax or punctuation. For tasks that involve repeated entry of date and time information, our invention can provide profound time savings over existing approaches to data entry.

We presume our invention's greatest value lies in applications that require extensive data entry of dates and times, such as a newspaper's compilation of listings of community events or any large organization's effort to maintain a shared calendar or schedule. However, our invention could also prove valuable when included in software intended for use by individuals for their own schedule planning and time management, a category sometimes referred to as “personal organizer software.”

We have implemented our invention in the context of software designed to organize and simplify the entry of community event information by a newspaper staff and by members of the community. This software, offered for sale with the title “NewsEngin EventTracker,” employs an HTML web browser for the user interface by which all data, including textual descriptions of the dates and times on which an event occurs, are submitted for processing.

### DETAILED DESCRIPTION OF THE INVENTION

The invention interprets textual descriptions of dates and times using a variety of rules that might generally be described as linguistic. The invention is structured as a sequence of three steps in a computer program to first standardize the formatting of the input text, then determine the linguistic significance of each word within the input text, and finally parse the input text from left to right in order to translate it into a list of machine-interpretable date-time values. A detailed description of each of these three steps follows.

### Step 1: Standardizing The Formatting of the Input Text

Because the invention needs to determine the linguistic significance of each word within the input text, we first subject the input text to a series of formatting and search-and-replace operations in order to constrain the set of possible words, punctuation and abbreviations whose meaning will be interpreted in a subsequent step. This reformatting is particularly important in subsequent identification of times of day, which can be input with any permutation of “a.m.” or “p.m.” Thus the following conversions are performed on the input text, in the order listed:
1) The text is converted to lower case.
2) Commas are removed from the text and replaced with spaces.
3) Any instances of the characters “a.m.”, “a.m”, “am.”, “a. m.”, “a m”, “a. m”, or “a m.” are converted to “am” to simplify the identification of times.
4) Any instances of the characters “p.m.”, “p.m”, “pm.”, “p. m.”, “p m”, “p. m”, or “p m.” are converted to “pm” to simplify the identification of times.
5) Any instances of the characters “--” are converted to “-”
6) Any instances of the words “every other” are converted to “everyother” so that the meaning of this phrase can be inferred from a single word.
7) Any instances of the words “every day”, “each day”, “every single day”, “each single day”, and “all days” are converted to “daily” so that their identical meaning can be inferred from a single word.
8) Any instances of the word “weekdays” are converted to “mondays tuesdays wednesdays thursdays fridays”.
9) Any instances of the word “weekends” are converted to “saturdays sundays”.
10) Any instances of the word “noon” are converted to “12 pm”.
11) Any instances of the words “midnight” or “midnite” are converted to “12 am”.
12) Any instances of the characters “hour)”, “hr)”, “hrs)”, or “h)” are converted to “hours)” to allow the correct identification of event durations.
13) Any instances of the characters “minute)”, “min)”, “mins)”, “mn)”, or “m)” are converted to “minutes)” to allow the correct identification of event durations.
14) Any instances of the words “matinee” or “matinees” are removed as they are redundant when a time is also specified.
15) Any instances of the words “as well as” are converted to “and”.
16) Leading spaces are removed from any instances of the characters “am”, “pm”, “hours)”, or “minutes)” so that these characters are concatenated with the numeric values that precede them, forming a single word.
17) Any instances of the phrase “between” followed by “and” are converted to “from” followed by “to”. For example, the expression “between May 15 and June 4” would be converted to “from May 15 to June 4”.

### Step 2: Linguistic Analysis of the Input Text

Our invention mimics the thought processes by which a person extracts the meaning from a complex textual expression of dates and times. Essential to that process is the ability to assess the significance of particular words that occur in such expressions. Therefore, our invention examines each word and attempts to classify it according to its linguistic role. It attempts to identify each word as a time, a date, a month, a day of the week, a conjunction, an ordinal number, a preposition indicating the start or end of a date range, a clause indicating dates to be excluded, or some other part of speech relevant to our interpretation of the overall text. Specifically, each word within the input text is classified according to the following tests, for which a discrete word is regarded as any combination of contiguous letters, numbers and punctuation that is either surrounded by spaces or positioned at the beginning or end of the entire expression (i.e., is the first or last word in the expression):
A word is classified as signifying the start of a date range if present in the following list: “after”, “following”, “from”, “frm”, “desde”, “start”, “starts”, “starting”, “begin”, “begins”, “beginning”, “open”, “opens”, “opening”, “meet”, “meets”, “meeting”, “convene”, “convenes”, “convening”, “launch”, “launches”, “launching”.
A word or item of punctuation is classified as signifying the end of a date range if present in the following list: “thru”, “through”, “tru”, “trhu”, “until”, “till”, “til”, “til”, “hasta”, “to”, “-”, “--”, “_”, “|”, “end”, “ends”, “ending”, “stop”, “stops”, “stopping”, “finish”, “finishes”, “finishing”, “conclude”, “concludes”, “concluding”, “close”, “closes”, “closing”.
A word is classified as signifying a day of the week if present in the following list: “sunday”, “monday”, “tuesday”, “wednesday”, “thursday”, “friday”, “saturday”, “sun”, “mon”, “tue”, “tues”, “wed”, “thu”, “thur”, “thurs”, “fri”, “sat”.
A word is classified as signifying a day of the week on which the event recurs if present in the following list: “sundays”, “mondays”, “tuesdays”, “wednesdays”, “thursdays”, “fridays”, “saturdays”.
A word is classified as signifying a month if present in the following list: “january”, “february”, “march”, “april”, “may”, “june”, “july”, “august”, “september”, “october”, “november”, “december”, “jan”, “feb”, “mar”, “apr”, “may”, “jun”, “jul”, “aug”, “sep”, “sept”, “oct”, “nov”, “dec”.
A word is classified as signifying the days on which an event recurs if present in the following list: “first”, “second”, “third”, “fourth”, “1st”, “2nd”, “3rd”, “4th”, “last”, “each”, “every”, “all”, “repeat”, “repeats”, “repeating”, “recur”, “recurs”, “recurring”.
A word is classified as signifying the interval at which an event recurs if present in the following list: “day”, “days”, “daily”, “week”, “weeks”, “weekly”, “month”, “months”, “monthly”.
A word is classified as signifying an alternating recurrence if present in the following list: “everyother”, “other”, “alternate”, “alternating”.
A word is classified as signifying that the subsequent word is a date if present in the following list: “on”, “for”.
A word is classified as signifying that the subsequent word is a time if present in the following list: “at”, “@”.
A word is classified as signifying a conjunction if present in the following list: “and”, “or”, “&”, “plus”, “+”.
A word is classified as signifying that any subsequent dates and times are to be excluded from the final list of occurrences if present in the following list: “skip”, “butnot”, “but”, “not”, “exclude”, “!”, “excluding”, “except”, “exept”, “accept”, “minus”, “less”, “without”.
A word is classified as signifying a time if its last two characters are “am” or “pm”.
A word is classified as signifying a time if it contains a colon.
A word is classified as signifying a range of times if it contains a colon and a hyphen.
A word is classified as signifying a duration if it contains a pair of parentheses.
A word is classified as signifying a range of dates if it contains an underscore.
A word is classified as signifying a range of dates if it contains at least one forward slash and one hyphen.
A word is classified as signifying a single date if it contains at least one forward slash or hyphen but not both.
A word is classified as signifying a year if it is a number between the value of the current four-digit year and 2199.
A word is classified as signifying a number (presumably a day of the month) if it is a numeric value less than the value of the current four-digit year.
A word is classified as signifying a range of months if it contains a hyphen separating two words denoting a month in full or abbreviated form, as in “aug-nov”.

### Step 3: Parsing the Input Text and Building a Result List of Dates and Times

After all words within the input text have been classified according to their linguistic significance, our invention reads through the entire expression from left to right and attempts to build a list of dates and times based on what it encounters. This list is the end result of the invention's processing, and is herein referred to as the result list. Depending on the nature of each word, the program calls a variety of subroutines designed to construct discrete dates and times from the phrase that begins with that particular class of word, with each subroutine adding its dates and times to the result list. As each phrase, which often constitutes only a portion of the entire expression, is parsed and converted to discrete dates and times, all words constituting that phrase are marked such that they cannot be re-evaluated. Thus in reading from left to right, the program might call a subroutine that processes the current word and several more that follow, if they are contextually related, before the program resumes reading left to right with the word immediately following the last word of the phrase just processed in the subroutine. The following is a detailed description of this date-building logic:
If the word's class indicates that what follows should be excluded from the final list of dates and times, a flag is set to indicate this condition so that any dates parsed subsequently are removed from the final result list.
If the word's class indicates that the word might be a specific date (typically a pair of numbers separated by a hyphen or forward slash), the program first checks to see if the prior word specified a month, in which case a hyphen-separated pair of numbers will be treated as indicating a range of dates within that month. If the word preceding the pair of hyphen-delimited numbers is not a month, then the numbers are treated as signifying the month and day, and the appropriate date is added to the result list. For example, if the word is “11-15,” this will be interpreted to mean next November 15 unless the prior word was classified as a month; if the prior word contained the value “aug”, the program would regard the event as recurring daily from August 11 through August 15.
If the word's class indicates that it specifies a range of dates, the date range is passed to a subroutine that adds each date in the range to the result list.
If the word's class indicates that it specifies a month, the program reads ahead two words to see if the second subsequent word was classified as a year. If so, that year is read and remembered as the year of the next dates to be added to the list; otherwise the year is assumed to be that in which the next instance of the date falls (i.e., if the current date is May 15 and the date to be added to the list has been specified as May 10, the program assumes the user meant May 10 of next year). The program regards the first word following the month as the numeric day portion of a date. Based on whether that numeric word is a single number or a pair of numbers separated by a hyphen, the program either adds one date to the result list or calls a subroutine to add all dates in the range to the result list.
If the word's class indicates that it is a single number, this is assumed to be an additional day for the month most recently specified. For example, in the phrases “May 5, 11, 14” or “5/5, 11, 14,” the lone numbers 11 and 14 will in either instance be added to the result list as May 11 and May 14.
If the word's class indicates the second half of a date range (the class of words such as “through” or “until”), a flag is set to indicate that the next date identified marks the end of a range for which the date previously identified marks the start. When the complete range has been identified, the program calls a subroutine to add the entire range of dates to the result list.
If the word's class indicates an ordinal specifying the interval at which an event recurs, the actual ordinal (“first,” “second,” “3rd,” “last”) is translated to a number or code (1, 2, 3, last) and passed to a subroutine. The subroutine in turn examines the next word and, if it finds a day of the week, adds the appropriate dates to the result list.
If the word's class indicates that it specifies an alternating recurrence, such as for an event that occurs every other Friday, the program calls a subroutine that examines the next word and, if it finds a day of the week, adds the appropriate dates to the result list.
If the word's class indicates that it specifies an event that occurs every week on a given day (e.g, “Thursdays”), the program calls a subroutine that adds the appropriate dates to the result list.
If the word's class indicates that it specifies an event that occurs daily, the program calls a subroutine that adds the appropriate dates to the result list.
If the word's class indicates that it specifies a time, the program associates the time with any previously generated dates in the result list that don't yet have times specified. In addition, the time is automatically associated with any subsequently generated dates for which no time is otherwise specified.
If the word's class indicates that it specifies a time range (e.g., “9 pm-10:30 pm”), the duration of the event is computed in the form of total minutes, and the program associates the start time and the event's duration with any previously generated dates in the result list that don't yet have times specified. In addition, the time and duration are automatically associated with any subsequently generated dates for which no time is otherwise specified.
   If the program identifies only the beginning of a date range but no end, all recurring dates in the input text will be treated as occurring after the start of the date range. Similarly, if only the end of a date range is identified, all recurring dates in the input text will be treated as occurring between the current date and the end of the date range.

1. What we claim as our invention is a computer program that accepts as input a textual description of the dates and times on which an event occurs or recurs, expressed in informal English with no special restrictions on syntax or punctuation, and provides as output a list of machine-interpretable dates and times representing each occurrence of the event described in the input text.

2. We additionally claim as our invention a system for linguistic classification of a textual description of dates and times on which an event occurs or recurs, expressed in informal English with no special restrictions on syntax or punctuation, with the purpose of such classification being the conversion of the textual description to a list of machine-interpretable dates and times.
